(19) United States
(12) Patent Application Publication
(10) Pub. No.: US 2009/0089353 A1
(43) Pub. Date: Apr. 2, 2009

(54) COMPUTER-READABLE MEDIUM STORING RELAY PROGRAM, RELAY DEVICE, AND RELAY METHOD

(75) Inventors: Shigeki Fukuta, Kawasaki (JP); Takao Mohri, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, kawasaki (JP)

(21) Appl. No.: 12/043,596

(22) Filed: Mar. 6, 2008

(30) Foreign Application Priority Data
Sep. 28, 2007 (JP) JP2007-253079

(51) Int. Cl. G06F 15/16

(52) U.S. Cl. 709/201

(57) ABSTRACT

A recording medium recording a relay program, relay method and device controlling a relay device which displays content information stored in a storage device on a display apparatus via a network. The relay method and system include receiving, from the display apparatus, an acquisition request for the content information in the storage device, transmitting predetermined identification information to the display apparatus which is a transmission source of the acquisition request in response to receiving the acquisition request for the content information, and transferring, from the storage device to the display apparatus, the content information corresponding to the acquisition request from the display apparatus when the identification information transmitted to the display apparatus is acquired from an information processing apparatus other than the storage device and the display apparatus.

### CROSS-REFERENCE TO RELATED APPLICATIONS

This application is related to and claims priority to Japanese patent application no. 2007-253079 filed on Sep. 28, 2007, in the Japan Patent Office, the disclosure of which is incorporated herein by reference.

### BACKGROUND

### Field

The present invention relates to relaying content information.

### SUMMARY

In view of solving existing problems associated with relaying information, an object of the present invention is to provide a computer-readable medium storing a relay program, a relay device, and a relay method. Even when a storage device and a display device are present on different networks, the disclosed relay program, device and method enable content information to be transferred from the storage device to the display device.

The disclosed relay device and method thereof includes controlling a relay device which displays content information stored in a storage device on a display apparatus via a network, receiving, from the display apparatus, an acquisition request for the content information in the storage device, transmitting predetermined identification information to the display apparatus which is a transmission source of the acquisition request, upon receiving the acquisition request for the content information, and transferring, from the storage device to the display apparatus, the content information indicated in the acquisition request from the display apparatus when the identification information transmitted to the display apparatus is acquired from an information processing apparatus other than the storage device and the display apparatus.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a configuration of a relay system;

FIG. 2 is a flowchart illustrating flow of operation(s) in relation to performing data transfer in the relay system of FIG. 1;

FIG. 3 illustrates a configuration of a relay system;

FIG. 4 is a block diagram an illustrating internal configuration of a gateway connected with an internal network shown in FIG. 3;

FIG. 5 illustrates an example of an access management table included in an access management function shown in FIG. 4;

FIG. 6 is a block diagram illustrating an internal configuration of a portable terminal shown in FIG. 3;

FIG. 7 is a block diagram illustrating an internal configuration of a display device shown in FIG. 3;

FIG. 8 is a flow illustrating operation(s) in relation to performing data transfer in a relay system;

FIG. 9 is a sequence chart illustrating, on a time serial basis, a flowchart for operation(s) in relation to performing data transfer in the relay system shown in FIG. 8;

FIG. 10 illustrates an example of a screen view of an access ID displayed on a display device;

FIG. 11 illustrates an example of a screen view of an access ID displayed on a portable terminal;

FIG. 12 is a flowchart illustrating a flow of operation(s) of a gateway;

FIG. 13 is a conceptual view illustrating operation(s) for producing access ID display content;

FIG. 14 is a conceptual view illustrating a flow of operation(s) of a relay system;

FIG. 15 is a conceptual view illustrating a flow of operation(s) of a relay system;

FIG. 16 is a conceptual view illustrating a flow of operation(s) of a relay system;

FIG. 17 is a sequence chart illustrating an example of operation(s) in a content selection process;

FIG. 18 illustrates a configuration of a relay system;

FIG. 19 is a block diagram illustrating an internal configuration of a transfer server and a gateway shown in FIG. 18;

FIG. 20 illustrates an example of device information;

FIG. 21 illustrates an example of a data acquisition request for requesting a data list;

FIG. 22 illustrates an example of a reply to a data acquisition request;

FIG. 23 illustrates an example of Playlist;

FIG. 24 illustrates an example of Playlist; and

FIG. 25 illustrates another example of Playlist.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Generally, a device (hereinafter referred to as an “internal device”) used for connection with the Internet from a home network (hereinafter referred to as an “internal network”), such as a LAN (Local Area Network) installed in a home or an office, is inhibited from being directly connected from the exterior and allows only the least necessary connection through an intermediating function, which is called a firewall or a gateway (hereinafter referred to collectively as a “gateway”), for the purpose of ensuring safety of communication security.

However, because the internal device connected to the internal network is restricted in connection through the gateway, the following problem occurs. When a user is outside the user's home and tries to make a connection with an internal device, which is connected to the internal network in the user's home, from a hand-held portable terminal (i.e., a portable terminal in an outside network differing from the internal network), a request for the connection is regarded as a connection coming from an exterior and is restricted. For example, even when a user tries to acquire data in a HDD recorder disposed inside the user's home by transferring the data to a display device (e.g., a TV) which is present near a cellular phone of the user outside the home, the connection to the internal network is restricted and the user cannot acquire the desired data.

To cope with the above-described situation, a gateway can be set such that a user outside the home can make connection with an internal device in an internal network even from a hand-held portable terminal of the user outside the home. The simplest device connection method in such a case is to perform a gateway setting, e.g., port mapping, such that an external device in the outside network can access the content of a particular internal device (e.g., a HDD recorder) in the internal network.

A technique of, if desired content is opened to the public on the Internet by a file server, etc., causing a substitute acquisition server instead of a portable terminal to acquire the content through control from the portable terminal has been developed. Further, from the viewpoint of preventing unauthorized access from a portable terminal to a data storage device, e.g., a HDD recorder, a technique of employing fingerprint data of a user of the portable terminal as an identifier for authentication, and allowing only authorized access from the portable terminal to the data storage device has been developed.

However, the above-mentioned typical techniques are based on the premise that the substitute acquisition server can access the file server, and it cannot be applied to the case where the file server is disposed within a LAN protected by a gateway.

It is also conceivable to acquire the content by a cellular phone connected to the user's home LAN through a VPN (Virtual Private Network), and to transfer the acquired content to a network device outside the user's home. Such a solution requiring intermediation of a portable terminal, however, has the following problems.

The weight of a portable terminal is required to be as small as possible in order that the portable terminal is easily portable. Therefore, the battery capacity is limited and the driving time of the portable terminal is also limited. Because power consumption is increased with an increase in workload and data communication traffic of the portable terminal, it is difficult for the portable terminal to intermediate data communication for a long time. Further, a CPU of the portable terminal is designed to have a relative low communication rate, taking into account the weight, the power consumption, etc. The relatively low level of calculation capability raises another problem of reducing the data communication rate.

It is practically not impossible that a user modifies a network device in an outside network, which is selected by the user to make communication with the internal device, to be able to directly communicate with the internal device on an ad-hoc basis. In such a case, however, the user is required to modify the gateway setting to a considerable extent from the exterior. From the viewpoint of necessary effort and time, it is practically unrealistic for the user to check information of the network device in the outside network and to perform the operation of modifying the gateway setting whenever the user ties to make communication from the outside.

Examples of a computer-readable medium storing a relay program, a relay device, and a relay method, according to embodiments of the present invention, will be described in detail below with reference to the accompanying drawings.

The term “content information (display information)” as referred to herein corresponds to data and content. The term “storage device” includes a data server, such as a HDD recorder, in the embodiments, and the term “display apparatus” corresponds to a display device, such as a TV. The term “relay device” and “computer” includes a gateway and a transfer server. The term “information processing apparatus” includes a portable terminal (device).

Further, the term “receiving unit of a relay device” corresponds to an access management function of a gateway and a transfer server. The term “identification information transmitting unit of the relay device” corresponds to an access-ID display content transfer function of a gateway and a transfer server. The term “transfer unit of the relay device” corresponds to an access permission inquiry function of a gateway and a transfer server and a data transfer function of the gateway and the transfer server.

In addition, the term “receiving operation” corresponds to an access management function of a gateway and a transfer server. The term “identification information transmitting” corresponds to an access-ID display content transfer function of a gateway and a transfer server. The term “transfer” or “transferring” corresponds to an access permission inquiry function of a gateway and a transfer server and the data transfer function of the gateway and the transfer server.

With the present invention, even when the storage device and the display device are present on different networks, content information can be transferred from the storage device to the display device while preventing unauthorized access.

Prior to describing the embodiments of the present invention with reference to the drawings, a technique on which the embodiments are based will be first described.

A system including a relay device (hereinafter referred to simply as a “relay system”), which is capable of transferring data in an internal network protected by a gateway to an external device outside the internal network through a remote control from a portable terminal of a user located outside, can be realized as follows. First, a portable terminal of a user located outside causes a gateway of an internal network to issue an access ticket, and receives the issued ticket. Then, the user transfers the access ticket from the user's portable terminal located outside to a display device which is present in front of the user at that time. The display device being present in front of the user accesses the gateway of the internal network by using the access ticket. As a result, the user of the portable terminal can access desired data in the internal network and can display the desired data in the internal network protected by the gateway on the display device located outside.

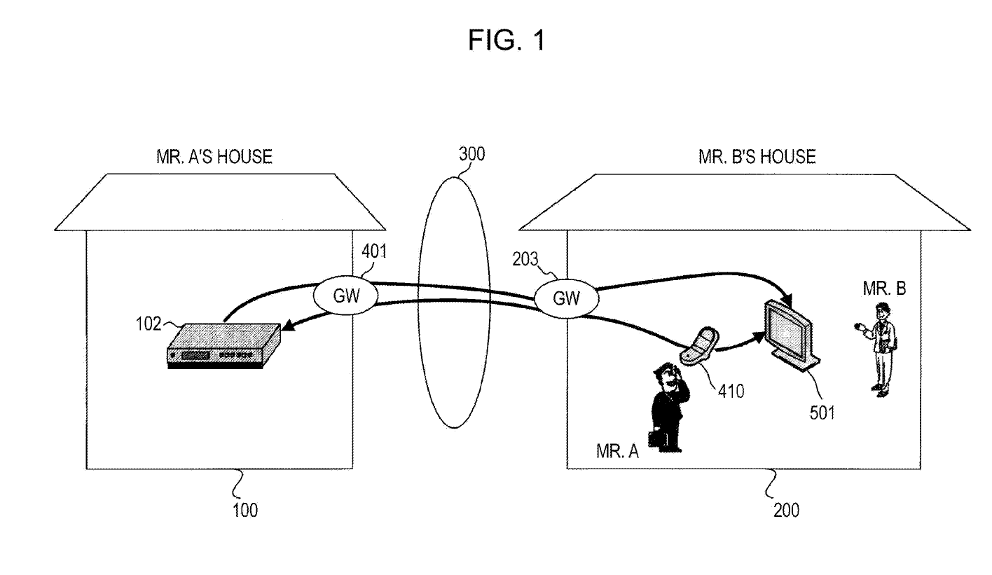

FIG. 1 shows a configuration of a relay system which represents a technique for embodiment(s) of the present invention. In the relay system shown in FIG. 1, it is assumed that Mr. A who is a user of a portable terminal 410 and a data server 102 visits Mr. B's house and shows Mr. B content desired by them. An outside network 200 located away from Mr. A's house and including a wireless LAN is in the Mr. B's house. A display device 501 capable of acquiring data and displaying the data is connected with the outside network 200. The display device 501 has a function of receiving an instruction from the portable terminal 410 and acquiring data from the data server 102 in the Mr. A's house remotely located away from the Mr. B's house. The portable terminal 410 may be, e.g., a cellular phone, a PDA (Personal Digital Assistant) etc. The outside network 200 in the Mr. B's house is connected with the Internet 300 via a gateway (GW) 203. Although description(s) pertaining to outside or away from home is provided herein, the present invention is not limited to exchanging content between particular locations or networks and may include various types of networks that generally restrict access thereto from outside the networks.

The gateway 203 serving to protect the outside network 200 in the Mr. B's house has a function of, similar to an ordinary gateway, allowing only a communication request directed from the interior toward the exterior, and rejecting a communication request coming from the exterior.

The data server 102 is disposed in the Mr. A's house. The data server 102 has a function of transmitting data in accordance with a predetermined protocol, such as HTTP (HyperText Transfer Protocol), FTP (File Transfer Protocol), etc. Further, the data server 102 is connected to an internal network 100 which is a LAN constructed in the Mr. A's house. The internal network 100 is connected to the Internet 300 via a gateway (GW) 401.

The gateway 401 serving to protect the internal network 100 has, in addition to an ordinary gateway function, a function of allowing communication that has a predetermined access ticket and is directed from an external device toward an internal device. Further, the gateway 401 has a function of receiving a communication device addition request from the external device that has a reliable predetermined access ticket, and of issuing a new access ticket.

The user (Mr. A) possesses the portable terminal 410 and carries it with him. The portable terminal 410 has a battery as a power supply and can be freely carried in a communicable state. Also, the portable terminal 410 has function(s) of wireless LAN and VPN (Virtual Private Network) so that a safe route using a device authentication function and a communication encrypting function can be set. With the VPN function, the portable terminal 410 can communicate with the gate 401 through the VPN and can establish connection to the internal network 100 in the Mr. A's house via the Internet 300.

Further, the portable terminal 410 can establish connection to the outside network 200 in the Mr. B's house by utilizing the communication function of the wireless LAN. In addition, the portable terminal 410 has a function of detecting various devices (such as the display device 510) in the outside network 200 to which the portable terminal 410 is connected. Such a device detection function can be realized by using an adapted protocol, e.g., UPnP AV (Universal Plug & Play Audio Visual). The UPnP AV can search for desired content, such as vide or music, on a home network, e.g., a domestic LAN, and can transfer the desired content to another device for reproducing the content.

Moreover, the portable terminal 410 has a function of requesting the gateway 401 installed in the Mr. A's house to set an external device (e.g., the display device 501), which has been detected outside, into a communicable state, and of acquiring a new access ticket. The portable terminal 410 can transfer the access ticket to the nearby external device (e.g., the display device 501), thus instructing the display device 501 to acquire predetermined data.

Here, Mr. A who is the user of the portable terminal 410 and the data server 102 and Mr. A visits Mr. B's house carrying the portable terminal 410. Mr. A connects the portable terminal 410 to the outside network 200 in the Mr. B's house. Then, Mr. A operates the portable terminal 410 such that the portable terminal 410 is connected to the internal network 100 through the VPN function. In accordance with operation(s) input to the portable terminal 410 from Mr. A, the portable terminal 410 performs preparations for transferring data within the data server 102, which belongs to the internal network 100 in the Mr. A's house, to the display device 501 on the outside network 200 in the Mr. B's house. Thereafter, the display device 501 accesses the data server 102 through the gateways 203 and 401 to acquire the data.

In the above-described relay system according to the prerequisite technique, access is made from the outside network 200 in the Mr. B's house to the internal network 100 in the Mr. A's house, while only a reply to the access is returned from the internal network 100 to the outside network 200. This means that communication(s) restricted by the gateway 203 of the outside network 200 are not generated. In the following, therefore, the description regarding the operation of the gateway 203 is omitted except for the case that a specific description is required.

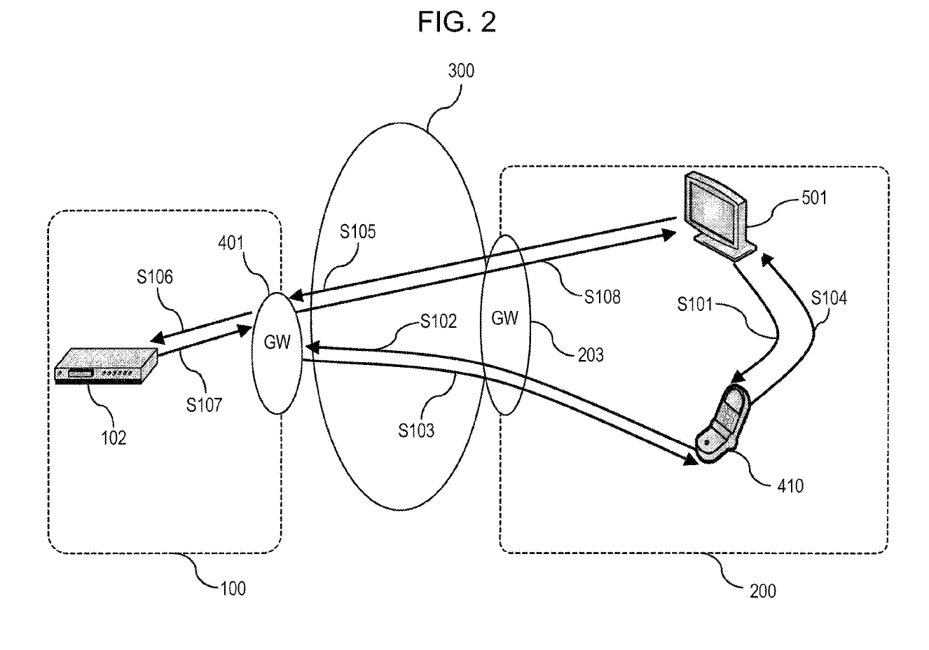

FIG. 2 is a flowchart showing a flow of operation(s) in relation to performing data in the relay system of FIG. 1. In a state shown in FIG. 2, Mr. A visits Mr. B and connects the portable terminal 410 to the outside network 200 based on permission of Mr. B.

In FIG. 2, the portable terminal 410 acquires device information from a nearby device (e.g., the display device 501) connected to the outside network 200 in the Mr. B's house (operation S101). The portable terminal 410 can acquire the device information from the nearby device, e.g., the display device 501, using an adapted protocol such as UPnP AV, etc. In such a way, the device information of the display device 501 is transmitted to the portable terminal 410.

Then, the acquired device information of the display device 501 is set from the portable terminal 410 to the gateway 401 of the internal network 100 in the Mr. A's house (home) (operation S102). Responsively, the gateway 401 sets and registers the device information of the display device 501 and sends the access ticket to the portable terminal 410 (operation S103). The term “access ticket” refers to management information that permits data access from an external device through the gateway 401 with restrictions. The access ticket defines details of the restrictions, including a time restriction (e.g., a restriction of connection time such as permitting a connection until P.M. 2 of today) and a repetition restriction (e.g., a restriction on a number of times of accesses, such as permitting only one access), etc.

When the access ticket is sent from the gateway 401 to the portable terminal 410, the portable terminal 410 sends an address of the gateway 401 and the received access ticket to the display device 501 (operation S104). Responsively, the display device 501 transmits a data acquisition request including the access ticket to the gateway 401 in the Mr. A's house, which corresponds to the received address (operation S105). When the gateway 401 confirms that the received access ticket is the authorized access ticket, the gateway 401 requests the data specified by the data acquisition request to the data server 102 (operation S106).

In response to the data acquisition request, the data server 102 transmits relevant data to the gateway 401 (operation S107). Then, the gateway 401 transfers, to the display device 501, the data transmitted from the data server 102 (operation S108). As a result, the display device 501 in the Mr. B's house can display on a screen thereof the data acquired from the data server 102 in the Mr. A's house.

In the relay system of FIG. 2, the portable terminal 410 instructs the display device 501 to acquire display data by notifying the display device of the address of the gateway 401 of the internal network 100 and the access ticket to the display device 501. In accordance with details of instruction(s) recorded in the access ticket, the display device 501 issues the data acquisition request to the gateway 401 which corresponds to the address provided from the portable terminal 410.

The gateway 401 of the internal network 100 compares the information and the access ticket, which have been registered and produced in operation S102, with the device information and the access ticket which have been added to the data acquisition request in operation S105. Only when they match with each other, the gateway 401 acquires the data instructed by the display device 501 from the data server 102, and transfers the data to the display device 501. As a result, the display device 501 can display or provide the data acquired from data server 102.

Thus, Mr. A who is the user of the portable terminal 410 and the data server 102 can control, by using the portable terminal 410, the gateway 401 disposed in the internal network 100 inside his own house from the Mr. B's house which is remotely located from his own house. Therefore, the portable terminal 410 can set the gateway 401 so as to permit data communication with the display device 501 on the outside network 200 in the Mr. B's house. Consequently, the display device 501 can acquire and display the data in the data server 102 disposed within the Mr. A's house through the gateway 401 that corresponds to the notified public address.

In the relay system shown in FIG. 2, however, because the display device 501 is required to have, e.g., a unit for acquiring the access ticket and a unit adding the access ticket at a time of access, a typical display device without modification may not be used as the display device 501.

Also, the typical display device adds, as information to be added when a data transfer request is issued (i.e., as an additional information), a simple character string (e.g., User Agent added when access is made in accordance with HTTP), and the additional information is insufficient for proper identification of individual devices. For example, when two display devices of the same type are present in the outside network 200, character strings of respective User Agents representing those two display devices are the same in most cases.

Further, when two display devices are present in the outside network 200 and the NAT (Network Address Translation) function of the gateway 203 is employed to access the Internet 300 from the outside network 200, IP addresses of these two display devices are the same when looked from the internal network 100, and hence those two display devices cannot be discriminated from each other.

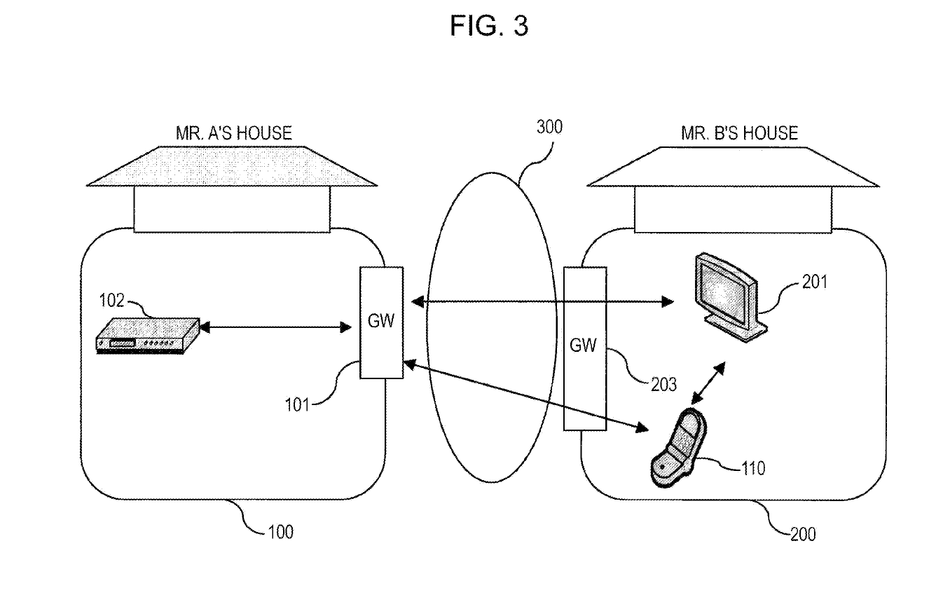

FIG. 3 shows a configuration of a relay system according to an embodiment of the present invention. In FIG. 3, the same symbols as those in FIG. 1 denote the same or equivalent components, and a description of those components is omitted here. Comparing with FIG. 1, the relay system of FIG. 3 includes a gateway 101, a portable terminal 110, and a display device 201.

In FIG. 3, an internal network 100 is constructed in Mr. A's house in which a data server 102 is disposed. The gateway 101 and the data server 102 are connected to each other. In the Mr. B's house which Mr. A is now visiting, an outside network 200 is constructed. The display device 201, the gateway 203, and the portable terminal 110 of Mr. A are connected to each other. Further, the internal network 100 in the Mr. A's house and the outside network 200 in the Mr. B's house are connected to each other via the Internet 300.

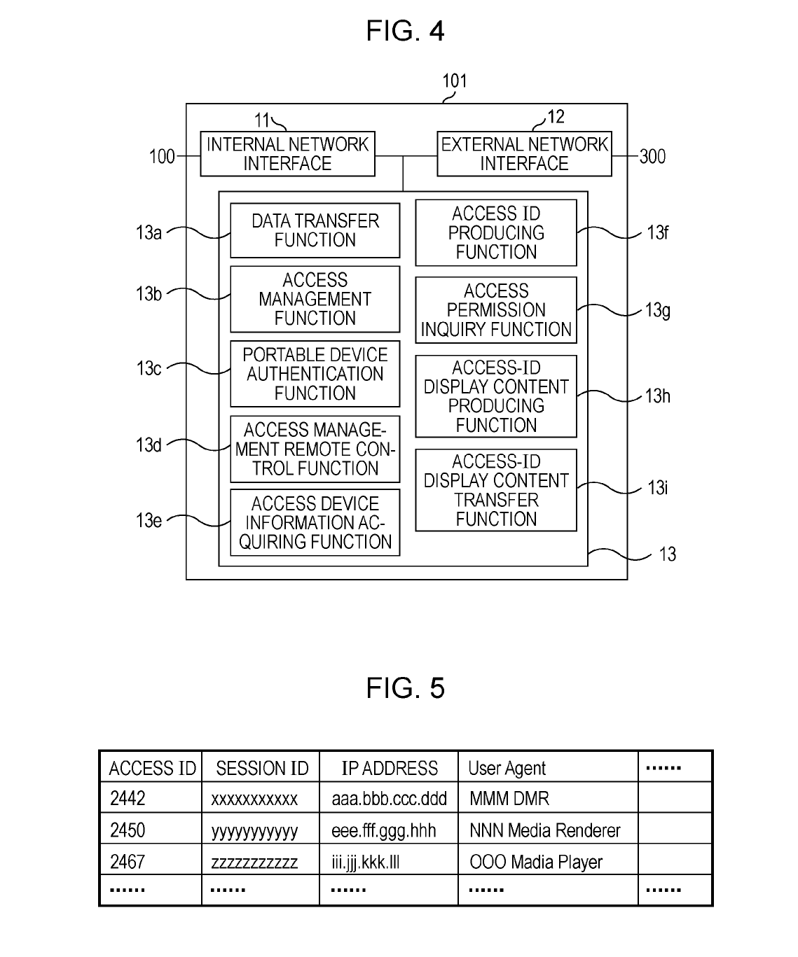

FIG. 4 is a block diagram showing a configuration of the gateway 101 connected with the internal network 100 in the Mr. A's house shown in FIG. 3. In FIG. 4, the gateway 101 is connected to the internal network 100 through an internal network interface 11 and is connected with the Internet 300 through an external network interface 12. Further, the gateway 101 has a relay function 13 connected to both the internal network interface 11 and the external network interface 12.

The relay function 13 has a data transfer function 13a transferring data stored in the data server 102, which is present in the internal network 100 in the Mr. A's house, to the display device 201 which is present in the outside network 200 in the Mr. B's house, an access management function 13b including an access management table that stores an access ID (identifier or identification information) and an IP address in a corresponding relation, and executing access management, a portable terminal (device) authentication function 13c authenticating the portable terminal 110 which has transmitted an authentication request, an access management remote control function 13d setting management of access to the internal network 100 through remote control from the portable terminal 110, etc., an access device information acquiring function 13e acquiring device information of the display device 201, etc., an access ID producing function 13f producing an access ID for access from the display device 201 to the internal network 100, an access permission inquiry function 13g inquiring, from the gateway 101, the portable terminal 110 about access permission and receiving an instruction of access permission (second information) or rejection from the portable terminal 110, an access-ID display content producing function 13h producing access-ID display content (first information) that is displayed on the display device 201, and an access-ID display content transfer function 13i transferring the produced access-ID display content to the display device 201.

FIG. 5 shows one example of access management table included in the access management function 13b shown in FIG. 4. The access management table records, for each access ID produced by the access ID producing function 13f, a session ID, an IP address, and a User Agent in a corresponding relation, which are prepared in accordance with HTTP. For example, the session ID of “xxxxxxxxxxxx”, the IP address of “aaa.bbb.ccc.ddd”, and User Agent of “MMM DMR” are recorded corresponding to the access ID of “2442”. Note that “MMR DMR”, etc. put in the column of User Agent are the names of hardware, software, etc.

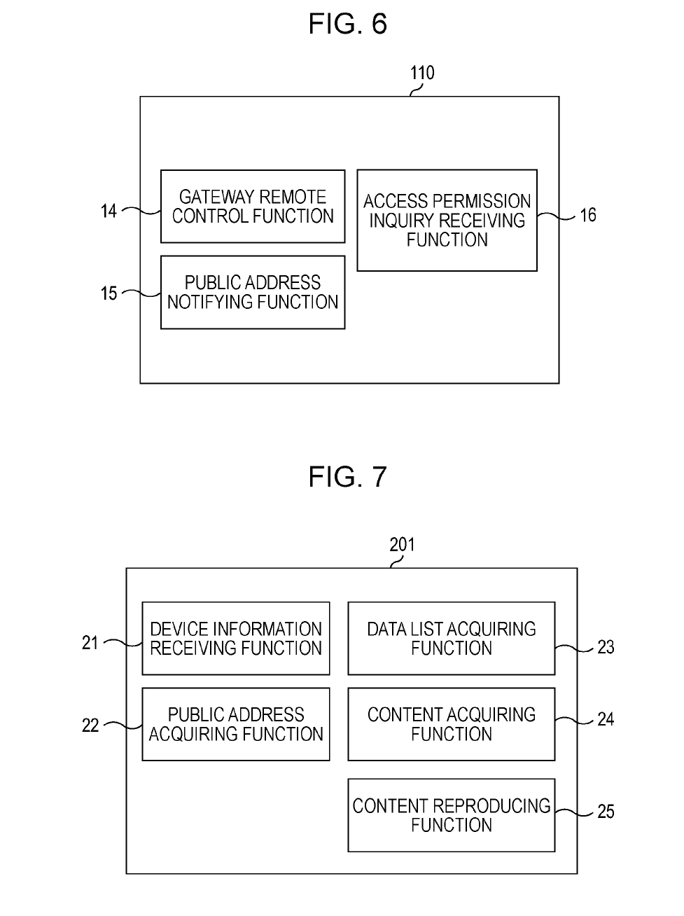

FIG. 6 is a block diagram showing a configuration of the portable terminal 110 shown in FIG. 3. The portable terminal 110 has a gateway remote control function 14 remotely controlling the access management remote control function 13d of the gateway 101, a public address notifying function 15 notifying a public address of the gateway 101 to the display device 201, and an access permission inquiry receiving function 16 receiving access permission inquiry information from the gateway 101.

FIG. 7 is a block diagram showing a configuration of the display device 201 shown in FIG. 3. The display device 201 has a device information receiving function 21 receiving device information of the data server 102, a public address acquiring function 22 acquiring the public address of the gateway 101, a data list acquiring function 23 acquiring a data list transmitted from the data server 102, a content acquiring function 24 acquiring the content transmitted from the data server 102, and a content reproducing function 25 reproducing the content acquired from the data server 102. The configuration of the display device 201 is the same as that of a display device which is adapted for typical network connection standards, e.g., DLNA (Digital Living Network Alliance). In other words, there is no need of adding any new function to the display device 201 for implementing the above-discussed embodiment.

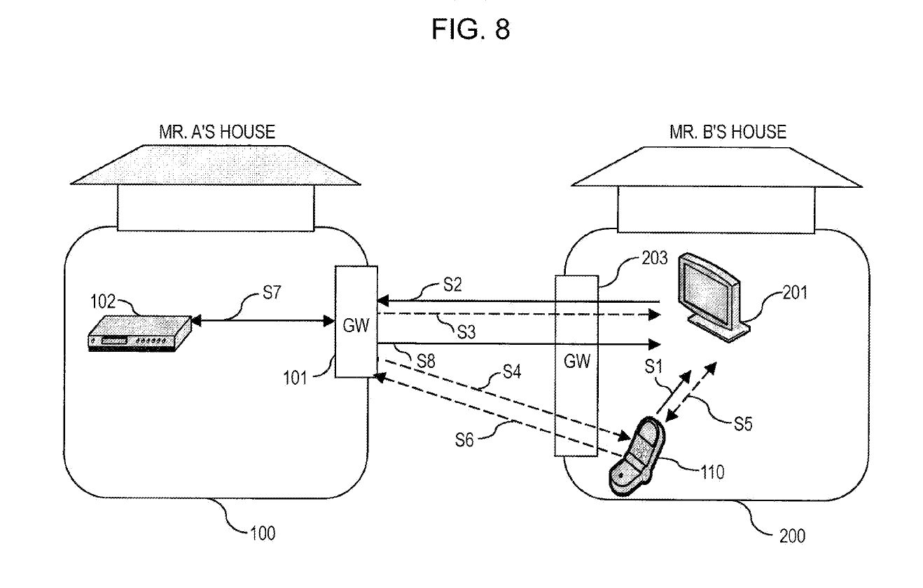

FIG. 8 is a flowchart showing a flow of operation(s) in relation to performing data transfer in a relay system according to an embodiment. In other words, FIG. 8 illustrates a flow of operation(s) until data is acquired in the relay system of FIG. 3.

In FIG. 8, the portable terminal 110 notifies a public address of the gateway 101 in the Mr. A's house to one of devices connected with the outside network 200 in Mr. B's house (i.e., the display device 201 in the illustrated example), on which the content is to be displayed, and also notifies a name of content to be displayed (hereinafter referred to as the “demanded content”) (operation S1). It is here assumed that communication setting and authentication are already performed between the gateway 101 and the portable terminal 110. In accordance with the received public address, the display device 201 makes a request for acquiring the demanded content to the gateway 101 (operation S2). At that time, a view indicating that the display device 201 is accessing the gateway 101 is displayed on the display screen of the display device 201.

Then, in response to the access of the data acquisition request from the display device 201, the gateway 101 produces an access ID and transmits, to the display device 201, content (hereinafter referred to as the “access ID display content”) for displaying, instead of the demanded content (e.g., videos), the access ID on the display device 201 in the same form as that of the demanded content. In other words, the access ID display content for displaying the access ID of the gateway 101 is transmitted to the display device 201 and is displayed on the display screen of the display device 201 (operation S3). Also, the gateway 101 notifies the access ID and the name of the demanded content to the portable terminal 110, and inquires access permission (operation S4).

The notification type of the information notified from the gateway 101 to the portable terminal 110 at that time can be the Push type used in mail, etc. or the Pull type used in HTTP, etc. Other information of the portable terminal (e.g., information regarding an IP address, a protocol used, etc.), which is obtainable at the gateway 101, may be added to the access ID. In such a case, character information including the access ID, the IP address, the display device information (User Agent), etc. are displayed on the display screen of the portable terminal 110. Further, a message of inquiring whether the access is permitted (i.e., an access permission inquiry) is displayed on the display screen of the portable terminal 110.

Then, the access IDs are displayed on both the portable terminal 110 and the display device 201 and are visually confirmed (verified) by the user (Mr. A) (operation S5). The information displayed for access confirmation (verification) is not limited to character strings of the access IDs and can be any other properly recognizable information including icons, videos, colors, fonts, or combinations thereof, so long as the user can recognize identity between the information displayed on the portable terminal 110 and the information displayed on the display device 201. When the demanded content is music, the access ID display content is given as, e.g., voices reading the access ID, and when the demanded content may be an image, an access ID display content may be given as, e.g., an image containing the character string of the access ID.

Instead of the visual confirmation by the user, the portable terminal 110 may automatically confirm an identity between both the access IDs, for example, by using a camera incorporated in the portable terminal 110 and a barcode displayed on the display device 201. Also, the identity between both the access IDs may be confirmed through communication between the portable terminal 110 and the display device 201.

When the user inputs an operation to indicate permission in response to the display of the message of the access permission inquire on the portable terminal 110, the portable terminal 110 transmits access permission to the gateway 101 so that the display device 201 is permitted to access the gateway 101 (operation S6). If the access permission is authorized, the gateway 101 acquires the data of the demanded content from the data server 102 (operation S7) and transfers the data to the display device 201 (operation S8). The flow for the data transfer process is thereby brought to an end.

As a result, the data stored in the data server 102 within the internal network 100 can be displayed on the display device 201 within the outside network 200.

With the above-described operations, even when one or more other display devices are present on a remote network such as the outside network 200, the user can discriminatively recognize the desired display device by confirming access ID(s) on both a portable terminal and a display device that is proximately positioned in front of the user.

Thus, the gateway 101 produces an access ID for each data acquisition request from the display device 201 and transmits a corresponding access ID display content to the display device 201. Further, the gateway 101 notifies an access situation to the portable terminal 110 as well. When the user operating the portable terminal 110 confirms the identity between the access IDs displayed on both the display device 201 and the portable terminal 110, the data in the data server 102 can be transferred to the display device 201 corresponding to only the authorized access. Stated another way, the user operating the portable terminal 110 can access the gateway 101 by confirming the details displayed on the display device 201.

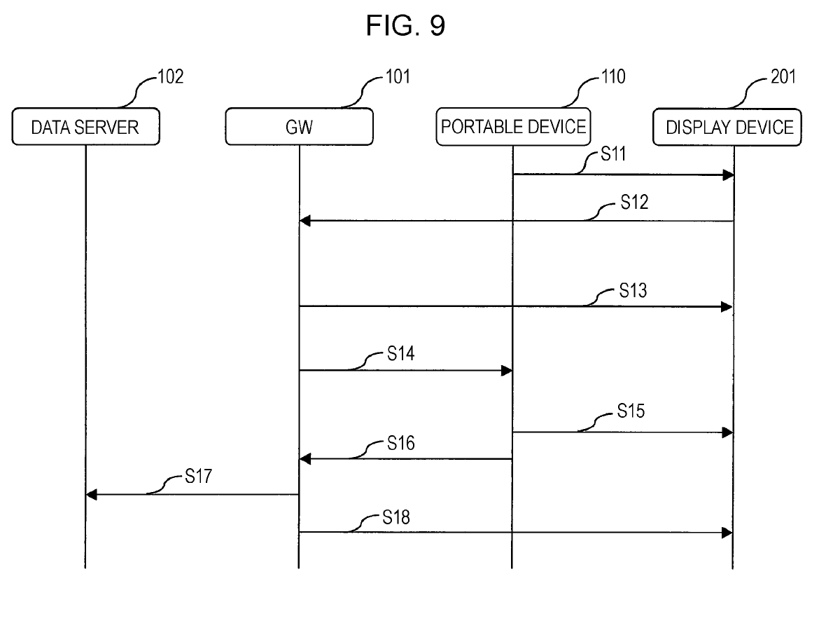

FIG. 9 is a sequence chart showing, on a time serial basis, a flowchart for operation(s) in relation to performing data transfer in the relay system shown in FIG. 8. As shown in FIG. 9, when an address of the gateway 101 and a name of a demanded content (“Video, ‘Summer 2007, Athletic Meeting’” in the illustrated example) are notified from the portable terminal 110 to the display device 201 (operation S11), a request for acquiring the demanded content is transmitted from the display device 201 to the gateway 101 corresponding to the address provided from the portable terminal 110 (operation S12). A name of a demanded content as referred to herein may be any identifier used to indicate a particular content.

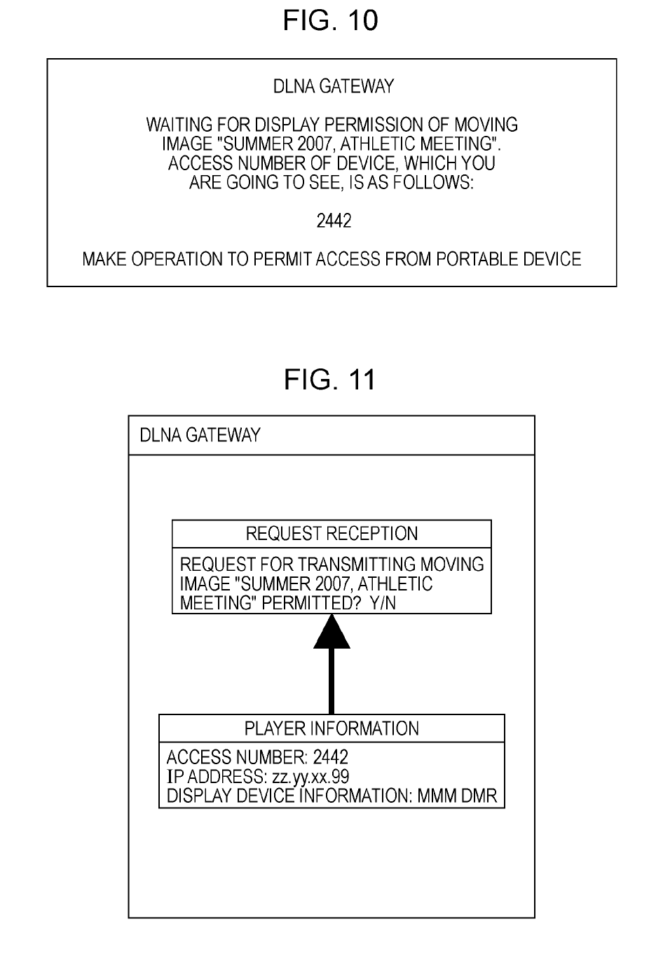

In response, the gateway 101 produces an access ID (“2442” in the illustrated example of FIG. 10) and an access ID display content, and then transmits the produced access ID display content to the display device 201 (operation S13). The display device 201 receives the access ID display content and displays the received access ID display content on a display screen thereof as shown in FIG. 10. FIG. 10 shows one example of a screen view of an access ID displayed on the display device 201. For example, the display device 201 displays, on a respective display screen, a state of the gateway 101 such as “DLNA GATEWAY WAITING FOR DISPLAY PERMISSION OF VIDEO ‘SUMMER 2007, ATHLETIC MEETING’”, the access ID such as “ACCESS NUMBER OF DEVICE BEING VIEWED IS AS FOLLOWS: 2442”, and an instruction such as “MAKE OPERATION FOR ACCESS PERMISSION FROM PORTABLE DEVICE”.

Returning to FIG. 9 again, the gateway 101 transmits the access ID and information of the display device 201, which have been transmitted as the access ID display content to the display device 201, to the portable terminal 110 as well, and inquires the portable terminal 110 about the access permission (operation S14). At that time, the portable terminal 110 displays, on a respective display screen, the access ID shown in FIG. 11.

FIG. 11 shows one example of a screen view of an access ID displayed on the portable terminal 110. The portable terminal 110, on a display screen thereof, displays a title indicating that the screen view is a message from “DLNA GATEWAY” (gateway 101), the message “REQUEST FOR TRANSMITTING VIDEO “SUMMER 2007, ATHLETIC MEETING” PERMITTED? Y/N” as request reception information (“REQUEST INFORMATION”), and player (display device) information (“PLAYER INFORMATION”) including “ACCESS NUMBER: 2442”, “IP ADDRESS: zz.yy.xx.99” of the display device 201, and “DISPLAY DEVICE INFORMATION: MMM DMR” of the display device 201.

Returning to FIG. 9 again, the user visually confirms an identity between the access ID displayed on the display device 201 and the access ID displayed on the portable terminal 110 (operation S15). If the identity between both the access IDs is confirmed, the portable terminal 110 transmits a reply, which indicates an access permission, to the gateway 101 in accordance with a user's operation (operation S16). The access permission includes, e.g., an access ID. Then, the gateway 101 sets the access permission from the display device 201, acquires the content from the data server 102 (operation S17), and transfers the acquired content to the display device 201 (operation S18).

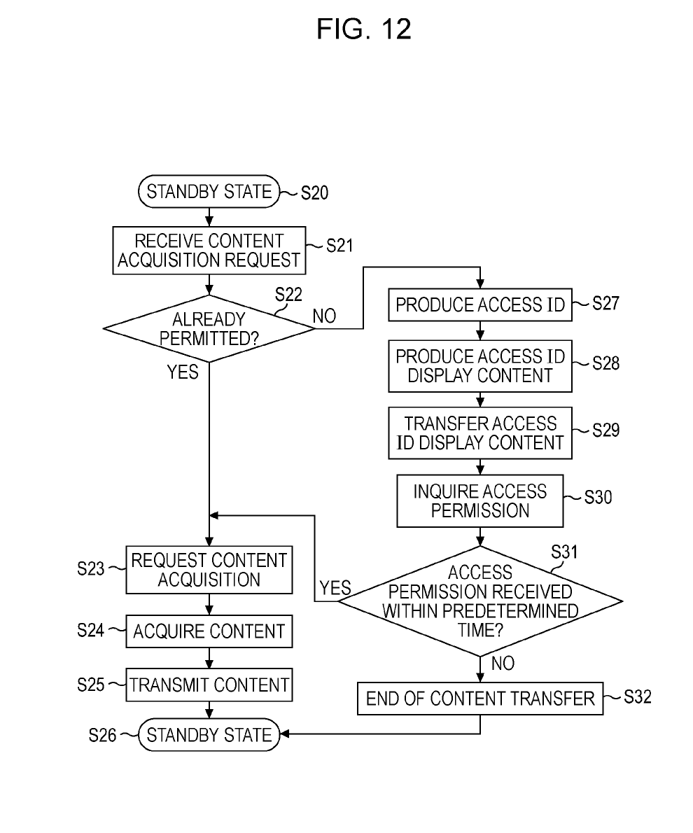

FIG. 12 is a flowchart showing a flow of operation(s) of the gateway 101. In FIG. 12, when the gateway 101 is in a standby state (operation S20) and receives a data (content) acquisition request for the demanded content from the display device 201 (operation S21), it is determined whether transmission of the demanded content is already permitted (operation S22).

If the transmission of the demanded content is already permitted (Yes in operation S22), the gateway 101 transmits a data acquisition request for the demanded content to the data server 102 (operation S23). Upon acquiring the demanded content from the data server 102 (operation S24), the gateway 101 transfers the acquired content to the display device 201 (operation S25) and comes into the standby state (operation S26). The operation flow of the gateway 101 is thereby brought to an end.

On the other hand, if the transmission of the demanded content is not yet permitted in operation S22 (i.e., No in operation S22), the gateway 101 produces an access ID (operation S27) and produces access ID display content (operation S28). Then, the gateway 101 transmits the access ID display content to the display device 201 (operation S29).

Further, the gateway 101 inquires the portable terminal 110 about an access permission (operation S30) and determines whether the access permission has been received from the portable terminal 110 within a predetermined time (operation S31). If the access permission has been received from the portable terminal 110 within the predetermined time (i.e., Yes in operation S31), the flow returns to operation S23 in which the data acquisition request for the demanded content is issued to the data server 102. Thereafter, the above-described processing subsequent to operation S24 is repeated.

On the other hand, if it is determined in operation S31 that the access permission is not received from the portable terminal 110 within the predetermined time (i.e., No in operation S31), the gateway 101 ends the content transfer to the display device 201 (operation S32) and comes into the standby state (operation S26). The operation flow of the gateway 101 is thereby brought to an end.

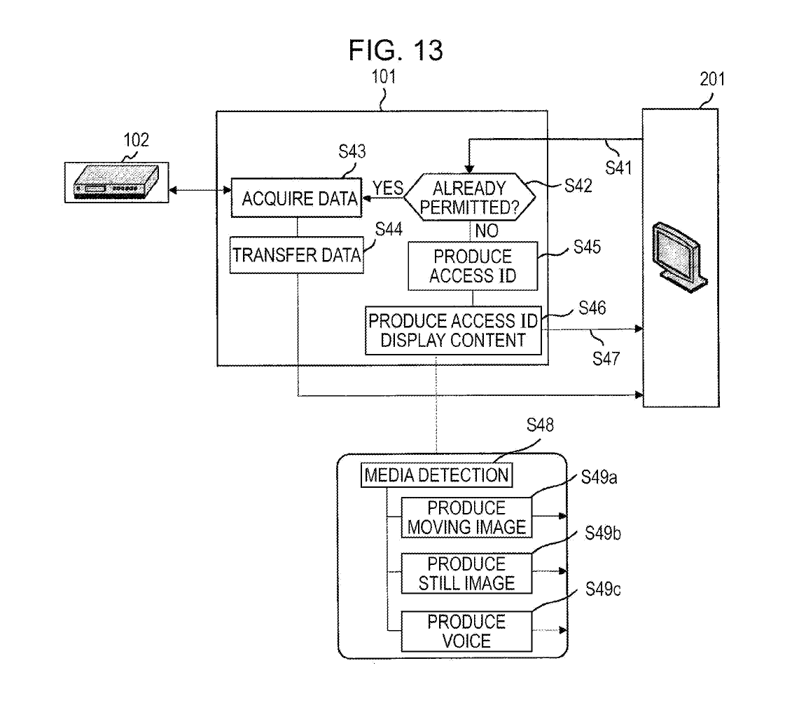

FIG. 13 is a conceptual view showing operation(s) for producing an access ID display content according to an embodiment. In FIG. 13, when the data acquisition request for the demanded content is transmitted from the display device 201 to the gateway 101 (operation S41), the access management function 13b of the gateway 101 determines whether transmission of the demanded content is already permitted (operation S42).

If the transmission of the demanded content is not yet permitted (i.e., No in operation S42), the access ID producing function 13f produces an access ID (operation S45), and the access-ID display content producing function 13h produces an access ID display content (operation S46). Then, the access-ID display content transfer function 13i transmits the access ID display content to the display device 201 (operation S47).

Details of operation S46 are shown in operations S48, S49a, S49b, and S49c. First, the access-ID display content producing function 13h detects media (form) of the demanded content (operation S48). Then, the access-ID display content producing function 13h produces the access ID display content in a form of video (operation S49a) if the form of the demanded content is a video, the access ID display content in a form of photo (operation S49b) if the form of the demanded content is a photo, and the access ID display content in a form of voice (operation S49c) if the form of the demanded content is voice.

On the other hand, if the transmission of the demanded content is already permitted (i.e., Yes in operation S42), the data transfer function 13a acquires the demanded content from the data server 102 (operation S43) and transfers the demanded content (i.e., actual content such as a video, a photo, voice, etc.) to the display device 201 (operation S44).

Thus, the display device 201 can realize the function of acquiring the access ID of the gateway 101 and displaying the acquired access ID by utilizing an existing function (i.e., a network connection function such as DLNA). In other words, the access ID can be displayed on the display device 201 without having to modify the display device 201. At that time, the gateway 101 transmits, to the display device 201, the information of the access ID in the same form as that of data to be acquired by the display device 201. Therefore, the display device 201 can display the information of the access ID similarly to media, such as a video, a photo and voice, which are supplied from the data server 102. After the operation(s) for confirming the access permission have completed in such a manner, the data server 102 transmits the substantial demanded content (actual content).

According to the relay system of the above-discussed embodiment, since the gateway 101 inquires an access permission for each access from the portable terminal 110, a user who possesses the portable terminal 110 can realize the transfer of data in the data server 102 to the display device 201 just by visually comparing two access IDs displayed on the display device 201 and the portable terminal 110, and selecting the access permission/no-permission. Further, since an access confirmation is made by utilizing an ordinary content form, the display device 201 is not required to have a new function for making the access confirmation.

In short, the relay system of the above-discussed embodiment can perform simple and flexible access control by utilizing equipment, as is, which is in conformity with typical network connection standards such as DLNA.

To cope with an attack to an intermediate section between the display device 201 and the gateway 101, the relay system may be added that confirms the gateway 101 and encrypts a communication, for example, by designing the display device 201 to be adapted for HTTPS (Hypertext Transfer Protocol Security). In such a case, information (e.g., fingerprint information of a certificate) for confirming certificate information issued by the gateway 101, etc. may be sent from the portable terminal 110 to the display device 201 in advance.

Another embodiment is described in connection with a protective operation to be performed when the above-described relay system is subjected to an erroneous operation or a tapping attack from a third party. The following description is made of the case that an access not expected by an owner of the portable terminal 110 is simultaneously attempted to the gateway 101 from another display device. Note that the descriptions of technique(s) and parts as those in the above described embodiment are not repeated here.

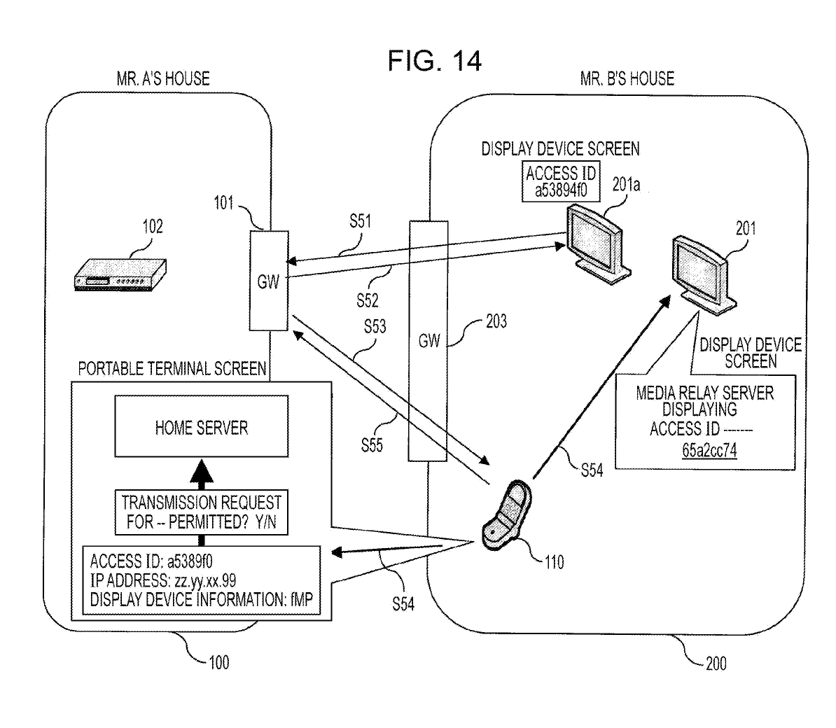

FIG. 14 is a conceptual view showing a flow of operation(s) of a relay system according to an embodiment. In FIG. 14, the same symbols as those in FIG. 3 denote the same or equivalent components, and a description of those components is omitted here. As shown in FIG. 14, a second display device 201a is also connected to the outside network 200 in addition to the display device 201. Here, the display device 201 is assumed to be in a state where it issues a data acquisition request to the gateway 101 in accordance with an instruction from the portable terminal 110. In response, the gateway 101 produces an access ID of the display device 201 and the access ID display content. The display device 201 displays an access ID display content. An access ID of the display device 201 is assumed here to be “65a2 cc74”. Further, the gateway 101 transmits the access permission inquiry, including the access ID of the display device 201, to the portable terminal 110.

If, in the above discussed state, the second display device 201a issues a data acquisition request (operation S51) in accordance with an instruction generated by an erroneous operation of the portable terminal 110 or an instruction from an attacker, e.g., a device attempting to tap into communication with the display device 201, the gateway 101 produces an access ID differing from the access ID of the display device 201 and access ID display content for displaying the produced access ID, and transmits it to the second display device 201a (operation S52). An access ID of the second display device 201a is assumed here to be “a53894fo”. Further, the gateway 101 transmits the access permission inquiry, including the access ID of the second display device 201a, to the portable terminal 110 (operation S53).

Accordingly, the portable terminal 110 displays, on a respective display screen, not only the access ID, the IP address, the display device information, etc. of the display device 201 on which the content is intended to be displayed, but also the access ID, the IP address, the display device information, etc. of the second display device 201a on which the content is not intended to be displayed.

The user of the portable terminal 110 compares the access ID “65a2 cc74” displayed on the display screen of the portable terminal 110 and representing the desired display device with the access ID “a53894fo” displayed on the display screen of the second display device 201a, and visually confirms that the access IDs are not identical to each other.

Also, the user of the portable terminal 110 visually compares the access ID “65a2 cc74” displayed on the display screen of the portable terminal 110 and representing the desired display device with the access ID “65a2 cc74” displayed on the display screen of the intended display device 201, and visually confirms that the access IDs are identical to each other (operation S54).

Further, when the user of the portable terminal 110 selects “Y” in reply to the access permission inquiry, i.e., “TRANSMISSION REQUEST FOR ACCESS ID: “a53894fo” PERMITTED? Y/N”, which is displayed on the display screen of the portable terminal 110, the portable terminal 110 transmits an access rejection to the gateway 101 (operation S55).

Moreover, when the user of the portable terminal 110 selects “N” in reply to the access permission inquiry, i.e., “TRANSMISSION REQUEST FOR ACCESS ID: “65a2 cc74” PERMITTED? Y/N”, which is displayed on the display screen of the portable terminal 110, the portable terminal 110 transmits an access permission to the gateway 101.

Therefore, the user can discriminatively recognize the display device 201 and the second display device 201a even when they are the same type display devices, and can reject the content display request from the second display device 201a on which the content is not intended to be displayed.

The above-described process is similarly applied to the case that the access permission inquiry with respect to the display device 201, on which the content is intended to be displayed, has not arrived at the portable terminal 110 due to a communication delay or some other cause.

In other words, the gateway 101 transmits a different access ID for each data acquisition request to the portable terminal 110 as well making inquiry regarding an access permission. Accordingly, the user can correctly determine the access permission by comparing the access ID displayed on the portable terminal 110 and the access ID displayed on the second display device 201a.

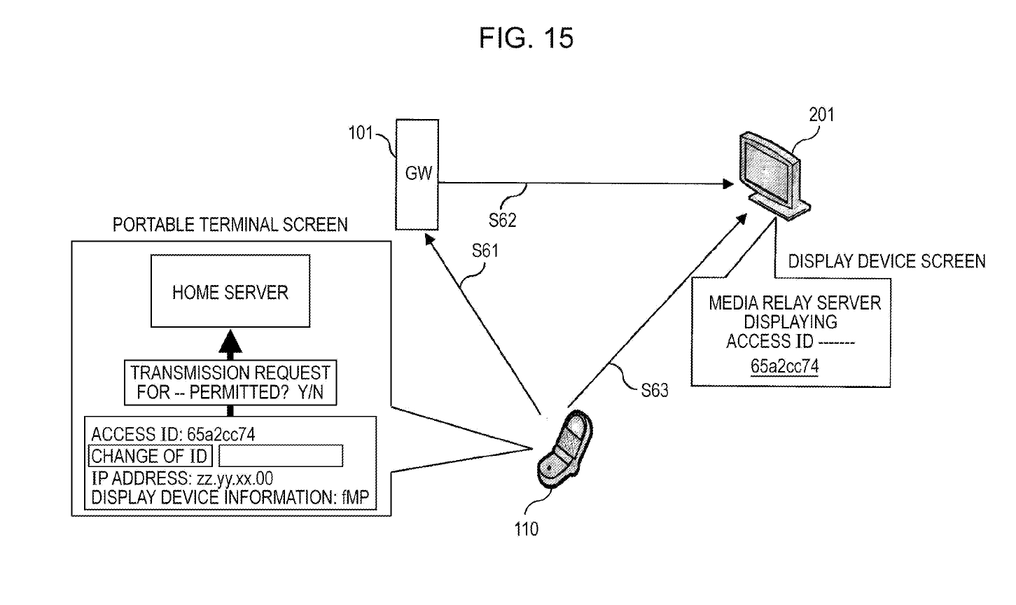

Another embodiment is described in connection with a relay system in which information for confirming access, i.e., access confirmation information, is changed. FIG. 15 is a conceptual view showing a flow of operation(s) of a relay system. In FIG. 15, the same symbols as those in FIG. 3 denote the same or equivalent components, and a description of those components is omitted here.

Here, access confirmation information is assumed to be an access ID. In the case of changing access ID of the display device 201, when the user inputs a new access ID in the portable terminal 110, the portable terminal 110 transmits an access ID change notification, including a new access ID, to the gateway 101 (operation S61). Responsively, the gateway 101 produces access ID display content from the new access ID and transmits the produced access ID display content to the display device 201 (operation S62). Therefore, the new access ID is displayed in each of the display screen of the portable terminal 110 and the display screen of the display device 201, thus allowing the user to visually confirm the access ID again.

Thus, according to the relay system of an embodiment, a device being accessed can be more reliably confirmed by dynamically changing an access confirmation information in accordance with an instruction from a portable terminal.

When an access ID is changed, the portable terminal 110 may automatically produce a new access ID, or the gateway 101 may produce the new access ID after receiving an instruction from the portable terminal 110. The access confirmation information is not limited to an access ID and may be an image or voice, for example, so long as a user can confirm an identity of information displayed on the portable terminal 110 and information display on the display device 201. Further, continuous changes in a state of the portable terminal 110, such as timings of continuous key operation(s), may be transmitted to the gateway 101 and displayed on the display device 201. In addition, an access confirmation may be automatically performed by acquiring information displayed on the display device 201 by using a microphone, a camera, etc., of the portable terminal 110.

In the relay system according to each of the above-described embodiments, the display device 201 acquires one data (content) from the data server 102 and displays the content. In another embodiment described here, however, the display device 201 acquires a list of various data, i.e., a data list, from the data server 102, and a user selects desired data from among the data list by operating the portable terminal 110 or displays the various data in the data list successively on the portable terminal 110.

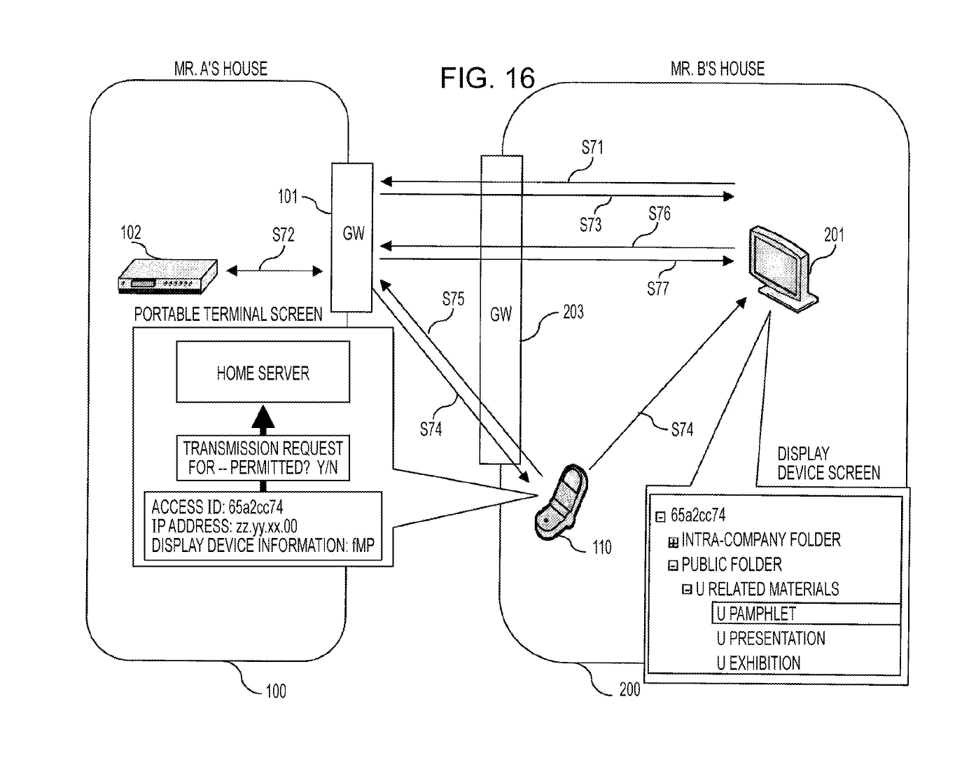

FIG. 16 is a conceptual view showing a flow of operation(s) of a relay system. In FIG. 16, the same symbols as those in FIG. 3 denote the same or equivalent components, and a description of those components is omitted here. In FIG. 16, the display device 201 transmits a data acquisition request requesting a data list to the gateway 101 (operation S71). Responsively, the gateway 101 acquires the data list from the data server 102 (operation S72). Based on the acquired data list, the gateway 101 produces a data list for displaying an access ID and transfers the produced data list to the display device 201 (operation S73).

The display device screen in FIG. 16 shows a display example of the data list. Herein, the gateway 101 displays the data list instead of the access ID display content by including, in the data list, a phantom item (file or folder) with an item name (file name or folder name) being the access ID.

Then, the gateway 101 transmits the access permission inquiry, including the access ID in the data list, to the portable terminal 110 (operation S74). Therefore, the user can confirm the access ID displayed on the portable terminal 110 and the access ID displayed on the display screen of the display device 201. If identity between the IDs is confirmed, the access permission is transmitted from the portable terminal 110 to the gateway 101 (operation S75).

After the operation of confirming the access ID by the portable terminal 110 has completed, the display device 201 reads the data list again (operation S76) and acquires, from the gateway 101, a substantial data list except for the access ID, thereby displays the list (operation S77).

Subsequently, the display device 201 displays the data list including the substantial content. When the content in the data list is selected by the user, the display device 201 transmits the data acquisition request for the selected content to the gateway 101. The content in the data list can be selected by an operation made on the portable terminal 110 or the display device 201. As shown in FIG. 16, a name of a selected content is displayed in a highlighted state on the display device screen.

On that occasion, when the gateway 101 receives, from the display device 201, the data acquisition request for the content in the data list having been transferred, the gateway 101 transfers the requested content from the data server 102 to the display device 201 without having to produce a new access ID or performing the access confirmation. As is practiced with existing protocol(s) (e.g., UPnP AV), the user selects the content in the data list by operating the display device 201 from the portable terminal 110.

Thus, according to the relay system of an embodiment, when the display device 201 first accesses a data list, an access ID is produced and confirmed. Thereafter, the display device 201 can access the content in the data list through the gateway 101. Accordingly, the user can select a plurality of contents in the data list and display the selected contents on the display device 201 just by performing the confirmation operation once.

A content selection process of selecting the content from the data list is now described. For sake of simplicity, a display device 201b is assumed to be connected to the internal network 100, and the following description is made of the content selection process between the data server 102 and the display device 201b within the internal network 100.

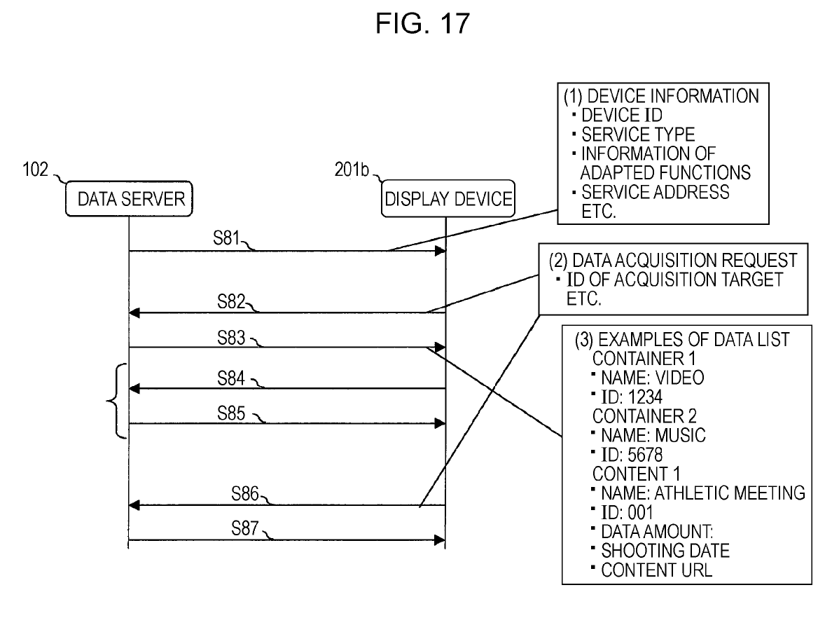

The content selection process is described here in connection with the case of using UPnP AV. In the UPnP AV, data is managed in a tree form and the data list is called a container. FIG. 17 is a sequence chart showing an example of operation(s) in a content selection process.

First, the data server 102 transmits its own device information in a broadcasting way, and the display device 201b receives the device information (operation S81). One example of the device information is shown in FIG. 17 as “(1) DEVICE INFORMATION” linked to operation S81. The device information includes “Device ID”, “Service type”, “Information of adapted functions”, “Service address” (address used as a destination of a data acquisition request), etc.

Then, the display device 201b transmits the data acquisition request for requesting the data list to the data server 102 (operation S82). One example of the data acquisition request transmitted at that time is shown in FIG. 17 as “(2) DATA ACQUISITION REQUEST” linked to operation S82 and S86. The data acquisition request includes “ID of acquisition target” as a data list or content, etc. Note that the ID of the container, which is the first acquisition target, is decided to be “0”.

In response to the data acquisition request, the data server 102 transmits the data list to the display device 201b (operation S83). One example of the data list transmitted at that time is shown in FIG. 17 as “(3) EXAMPLE OF DATA LIST” linked to step S83. The illustrated data list includes “CONTAINER 1”, “CONTAINER 2”, and “CONTENT 1”. “CONTAINER 1” includes “Video”. “CONTAINER 2” includes “Music”. “CONTENT 1” includes “Name”, “ID”, “Data amount”, “Shooting date”, “Content URL” (destination used for acquiring the content), etc.

When a lower-level data list is designated in the display device 201b, the display device 201b transmits the data acquisition request for a new data list to the data server 102 (operation S84). In response to the data acquisition request, the data server 102 transmits a new data list to the display device 201b (operation S85). Steps S84 and S85 are repeated until the content is requested.

The display device 201b transmits the data acquisition request for the content to the data server 102 (operation S86). In response to the data acquisition request, the data server 102 transmits the content to the display device 201b (operation S87). The sequence shown in FIG. 17 is thereby brought to an end.

Between the data server 102 and the display device 201, a content selection process is executed in a similar manner to the above-described sequence through the gateway 101.

In a relay system according to another embodiment, a transfer server 103 is disposed in the internal network 100 inside the user's house (Mr. A's house) and operation(s) such as producing and transmitting the access ID, which are executed by the gateway 101 in the above-described embodiments, are executed by the transfer server 103. The transfer server 103 is realized with a computer, e.g., a PC.

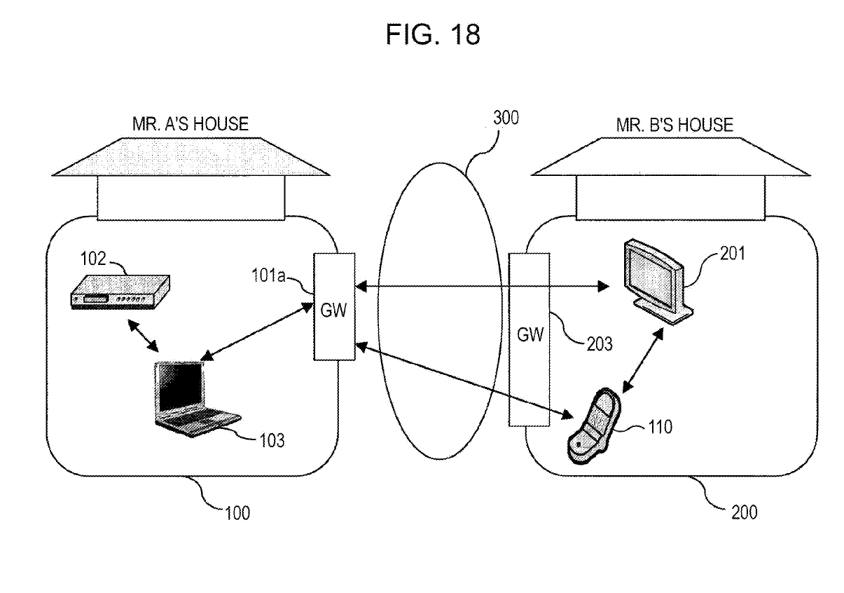

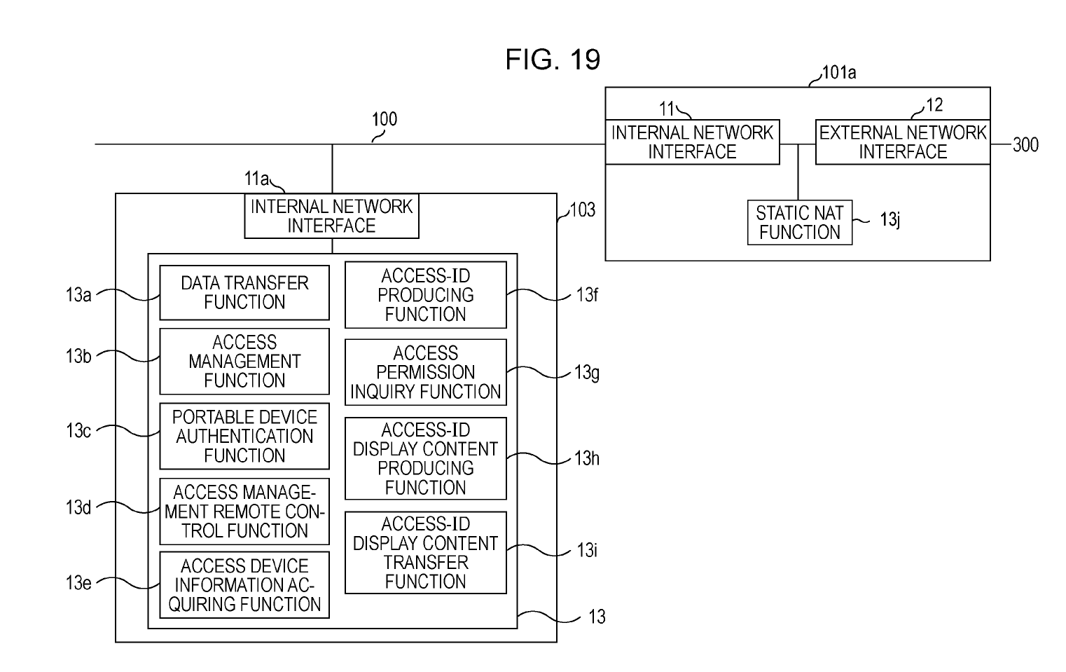

FIG. 18 shows a configuration of a relay system according to an embodiment. In FIG. 18, the same symbols as those in FIG. 3 denote the same or equivalent components, and a description of those components is omitted here. FIG. 19 is a block diagram showing an internal configuration of the transfer server 103 and a gateway 101a both shown in FIG. 18. The configuration of the relay system of FIG. 18 differs from that of the relay system of FIG. 3 in including a gateway 101a instead of the gateway 101 and a transfer server 103 within the internal network 100.

More specifically, the transfer server 103 includes the relay function 13 that is possessed by the gateway 101 in each of the above-described embodiments, and an internal network interface 11a for connection to the internal network 100. The gateway 101a is constituted by a known simple gateway and includes an internal network interface 11 for connection to the internal network 100, an external network interface 12 for connection to the Internet 300, and a static NAT (Network Address Translator) function 13j for executing a static NAT process between the internal network 100 and the Internet 300.

With such a configuration, similar to the above-described gateway 101, a transfer server 103 produces an access ID in response to the data acquisition request from the display device 201 and transmits access ID display content for displaying the produced access ID to the display device 201 via the gateway 101a. Further, the transfer server 103 transmits an access permission inquiry, including the produced access ID, to the portable terminal 110, receives access permission or no-permission from the portable terminal 110, and controls access from the display device 201. Since the remaining operations of the relay function 13 are the same as those previously described embodiment, a duplicate description of those operations is omitted here.

Accordingly, even with the gateway 101a, the data server 102, and the display device 201 all having the known functions, similar advantages to those in the above-described embodiments can be obtained just by adding a new transfer server to the internal network 100.

An embodiment is described in connection with application examples of the relay systems according to the above-described embodiments. In each of the above-described embodiments, there is a possibility that, an access ID display content is transferred to the display device prior to a demanded content, some display device may malfunction by erroneously recognizing the access ID display content as the demanded content. To cope with such a malfunction, in the data server 102 prepares Playlist as content for viewing, listening, and accessing a plurality of content(s), and a function of successively looking and listening the contents by Playlist is added to the display device 201 so that the display device 201 can successively display the access ID display content and the demanded content.

Further, a Playlist may be displayed instead of the access ID display content by including, in Playlist, a phantom item (content or folder) with an item name being the access ID.

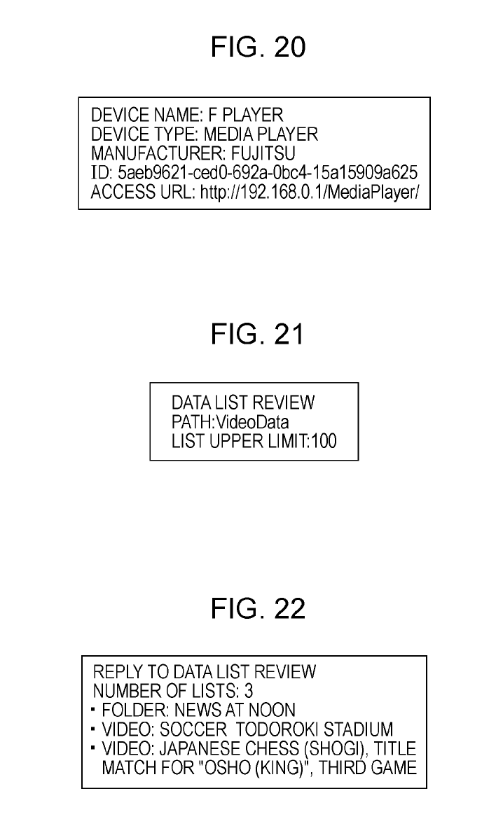

FIG. 20 shows one example of device information. The illustrated device information corresponds to information transmitted in the above-described operation S81 and includes, e.g., “Device name”, “Device type”, “Manufacturer”, “ID”, and “Access URL”.

FIG. 21 shows one example of a data acquisition request for requesting a data list. The illustrated data acquisition request corresponds to information transmitted in the above-described operations S82 and S84. It includes a title indicating that a relevant message is a data list review request, a path for the data list requested, and an upper limit of the item number in the data list.

FIG. 22 shows one example of a reply to a data acquisition request. The illustrated reply corresponds to the information transmitted in the above-described operations S83 and S85. It includes a title indicating that the relevant message is a reply to the data list review, the number of items in the data list, and the contents of the data list (list of items in Playlist).

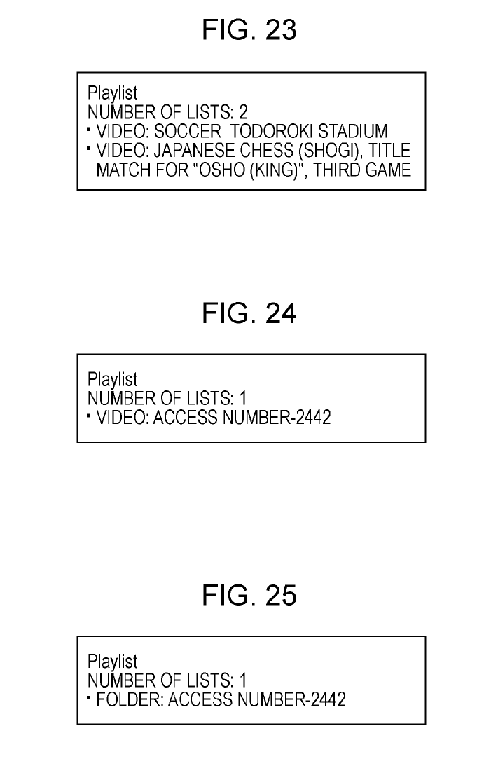

FIG. 23 shows an example of Playlist. As in the data list, Playlist includes a title indicating a relevant message is Playlist, number of items in Playlist, and contents of Playlist (list of items in Playlist). The items are arranged in an order in which they are reproduced.

FIG. 24 shows an example of Playlist according to an embodiment of the present invention. The illustrated Playlist includes the phantom content with the content name being the access ID. FIG. 25 shows another example of Playlist according to an embodiment of the present invention. The illustrated Playlist includes the phantom content with the folder name being the access ID.

In the above-described embodiments, the gateway 101 and the portable terminal 110 inside the user's house perform communication while securing a safe route, such as VPN, via the external network including, e.g., the gateway 203 of the outside network and the Internet. In the present invention, however, the portable terminal 110 may communicate with the home gateway 101 by utilizing another communication device. For example, the portable terminal 110 may be connected to the external network, e.g., the Internet, to perform VPN communication with the gateway 101 without requiring intermediating of the outside LAN 200 and gateway 203 by utilizing a public line, such as a cellular phone network or a PHS (Personal Handy-phone System) network. Further, an RAS (Remote Access Server) may be installed in the home LAN 100 for direct connection to the portable terminal 110 via the public line.

According to the disclosed relay device, a display apparatus (display device) can acquire an access ID from a computer (gateway) and display the acquired access ID by utilizing existing function(s) as they are. In other words, the access ID can be displayed by utilizing a typical display apparatus, as is, Which is adaptable for a network connection.

Also, according to the disclosed relay device, since a gateway inquires access permission in accordance with an instruction from an information processing apparatus (portable terminal), a user of the portable terminal can transfer data in a storage device (data server) to t a display apparatus just by visually confirming identity between access IDs displayed on the display apparatus and the portable terminal, and by selecting access permission/no-permission.

Stated another way, a storage device (data server) in the user's house is just required to have the existing transmitting function with no need of adding a new function. The display apparatus located outside the user's house is also just required to have an existing reproducing function with no need of adding a new function. Further, since the user of the portable terminal is just required to confirm the access information and inputs the access permission, necessary operation(s) are very simple. Thus, the relay system of the present invention can perform simple and flexible access control by utilizing the existing equipment as is. In addition, according to the relay device of the present invention, since access IDs of a plurality of display apparatuses can be discriminately recognized, individual contents can be separately transmitted to the plurality of display apparatuses.

Moreover, a program for executing the above-described operations in a computer, which constitutes the relay device, can be provided as a relay program. The program can be executed by the computer constituting the relay device by storing the program in a computer-readable storage medium. Examples of the computer-readable storage medium include an internal storage device, such as a ROM or a RAM, incorporated in the computer, a portable storage medium such as a CD-ROM, a flexible disk, a DVD disk, a magneto-optical disk or an IC card, a database holding a computer program, another computer or a database therein, and a transmission medium on a line.

The present invention can be practiced in various forms without departing from the spirit or the primary feature of the invention. Accordingly, the above-described embodiments are given only by way of illustrative examples in all respects and should not be construed in a limiting sense. The scope of the present invention is defined only by claims and is in no way restricted by the text of the specification. In addition, various modifications, improvements, alternatives, and reformations, which fall within a scope equivalent to the scope defined in claims, are all involved in the present invention.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A computer-readable recording medium recording a relay program causing a computer to execute operations including controlling a relay device which displays content information stored in a storage device on a display apparatus via a network, the operations comprising:
receiving, from the display apparatus, an acquisition request for the content information in the storage device;
transmitting predetermined identification information to the display apparatus which is a transmission source of the acquisition request, upon receiving the acquisition request for the content information; and
transferring, from the storage device to the display apparatus, the content information indicated in the acquisition request from the display apparatus when the identification information transmitted to the display apparatus is acquired from an information processing apparatus other than the storage device and the display apparatus.

2. The recording medium recording the relay program according to claim 1, wherein the identification information and the content information are displayed on the display apparatus.

3. The recording medium recording the relay program according to claim 1, wherein the acquisition request received for the content information is managed as part of the identification information.

4. The recording medium recording the relay program according to claim 1, wherein the identification information is acquired by transmitting a request for the identification information to the information processing apparatus.

5. The recording medium recording the relay program according to claim 1, wherein content information representing the identification information is produced and transmitted to the display apparatus.

6. A relay device for displaying content information stored in a storage device on a display apparatus via a network, the relay device comprising:
a receiving unit receiving, from the display apparatus, an acquisition request for the content information in the storage device;
an identification information transmitting unit transmitting predetermined identification information to the display apparatus which is a transmission source of the acquisition request, upon receiving the acquisition request for the content information by the receiving unit; and
a transfer unit transferring, from the storage device to the display apparatus, the content information indicated in the acquisition request from the display apparatus when the identification information transmitted to the display apparatus is acquired from an information processing apparatus other than the storage device and the display apparatus.

7. A control method for a relay device which displays content information stored in a storage device on a display apparatus via a network, the control method comprising:
receiving, from the display apparatus, an acquisition request for the content information in the storage device;
transmitting predetermined identification information to the display apparatus which is a transmission source of the acquisition request, upon receiving the acquisition request for the content information; and
transferring, from the storage device to the display apparatus, the content information indicated in the acquisition request from the display apparatus when the identification information transmitted to the display apparatus is acquired from an information processing apparatus other than the storage device and the display apparatus.

8. A method of controlling a relay device, comprising:
transmitting identification information to a transmission source of content information in response to a request for content; and
transferring the content from a first network to a second network of said transmission source in response to determination that said identification information matches data provided using an portable device.
